(19) United States
(12) Patent Application Publication
(10) Pub. No.: US 2020/0050897 A1
(43) Pub. Date: Feb. 13, 2020

(54) Method for Determining Sentiment Threshold and Artificial Intelligence Device

(71) Applicant: Huawei Technologies Co., Ltd., Shenzhen (CN)

(72) Inventors: Mingjie Dong, Shenzhen (CN); Kangmin Huang, Shenzhen (CN); Wenhua Sun, Shenzhen (CN)

(21) Appl. No.: 16/657,576

(22) Filed: Oct. 18, 2019

Related U.S. Application Data
(63) Continuation of application No. PCT/CN2018/083885, filed on Apr. 20, 2018.

(30) Foreign Application Priority Data
Apr. 20, 2017 (CN) 201710262505.9

(51) Int. Cl. G06K 9/62; G06F 17/18; G06K 9/00; G06N 20/00

(52) U.S. Cl. CPC G06K 9/6264; G06F 17/18; G06N 20/00; G06K 9/00335; G06K 9/6293

(57) ABSTRACT

A sentiment threshold determining method and an artificial intelligence device configured for determining, based on obtained monitoring information, that a sentiment status of a first user is a first sentiment state, obtaining N actions of a second user, determining a first action based on a Q-value table, updating a Q value that corresponds to the first sentiment state and the first action in the Q-value table, determining whether an updated Q value is greater than a preset threshold. Finally, determining the sentiment threshold based on the monitoring information, and when the updated Q value is greater than a preset threshold, updating the sentiment status, or repeating the foregoing steps until the sentiment threshold is determined when the updated Q value is not greater than the preset threshold.

### CROSS-REFERENCE TO RELATED APPLICATIONS

This application is a continuation of International Patent Application No. PCT/CN2018/083885 filed on Apr. 20, 2018, which claims priority to Chinese Patent Application No. 201710262505.9 filed on Apr. 20, 2017. The disclosures of the aforementioned applications are hereby incorporated by reference in their entireties.

### TECHNICAL FIELD

This application relates to the artificial intelligence field, and to a method for determining a sentiment threshold, and an artificial intelligence device.

### BACKGROUND

With continuous development of artificial intelligence, a primary task for an artificial intelligence system is possessing a sentiment connection capability for “sensibility” to meet people's common requirements in mentality and sentiment in a more humanized manner and gradually build trust and attachment. Artificial intelligence should not merely be an ordinary intelligence tool, and should not always develop along a rational way but should fall within an intersection area between sensibility and rationality.

Sentiment computing plays an important role in the development of artificial intelligence. A growing quantity of products with “sentiment” appear and this is merely a start. Human emotion is an extremely complex issue, and artificial intelligence still has a long way to go.

In one approach, a user's sentiment is determined by the artificial intelligence device by comparing an obtained sensor parameter used to monitor physiological information of a user with a preset sentiment threshold. For example, it may be determined that a sentiment status of the user changes if the obtained sensor parameter is greater than the sentiment threshold or it may be determined that a sentiment status of the user does not change when the obtained sensor parameter is not greater than the sentiment threshold.

In the foregoing technical solutions, the sentiment threshold is preset in the artificial intelligence device. Sentiment thresholds of different users may be different, and sentiment thresholds of a user in different scenarios may also be different. Therefore, how to determine sentiment thresholds to adapt to different users is a problem to be resolved.

### SUMMARY

This disclosure provides a method for determining a sentiment threshold and an artificial intelligence device to optimize a sentiment threshold and improve communication efficiency and communication effects in different scenarios.

According to a first aspect, an embodiment provides a method for determining a sentiment threshold and an artificial intelligence device. The method includes steps for: determining, by an artificial intelligence device based on obtained monitoring information, that a sentiment status of a first user is a first sentiment state; obtaining, by the artificial intelligence device, N actions of a second user, where the second user is a user who communicates with the first user, and N is a positive integer greater than or equal to 1; determining, by the artificial intelligence device, a first action based on a Q-value table, where each Q value in the Q-value table corresponds to a sentiment state and an action, a Q value that corresponds to the first sentiment state and the first action is a largest value in N Q values in the Q-value table, and an n^{th} Q value in the N Q values corresponds to the first sentiment state and an n^{th} action in the N actions, where n=1, . . . , N; updating, by the artificial intelligence device, the Q value that corresponds to the first sentiment state and the first action in the Q-value table; determining, by the artificial intelligence device, whether an updated Q value is greater than a preset threshold, and determining the sentiment threshold based on the monitoring information, and when the artificial intelligence device determines that the updated Q value is greater than the preset threshold updating the sentiment status, or repeating the foregoing steps until the sentiment threshold is determined, when the artificial intelligence device determines that the updated Q value is not greater than the preset threshold, where an updated Q value greater than the preset threshold indicates that the sentiment status of the first user changes from the first sentiment state to a specific sentiment state. In the foregoing technical solution, the artificial intelligence device may optimize the sentiment threshold using a Q-learning method to improve communication efficiency and communication effects in different scenarios.

With reference to the first aspect, in a first possible implementation of the first aspect, updating, by the artificial intelligence device, the Q value that corresponds to the first sentiment state and the first action in the Q-value table includes updating, by the artificial intelligence device based on a first return rate, the Q value that corresponds to the first sentiment state and the first action in the Q-value table.

With reference to the first possible implementation of the first aspect, in a second possible implementation of the first aspect, updating, by the artificial intelligence device based on a first return rate, the Q value that corresponds to the first sentiment state and the first action in the Q-value table includes updating, by the artificial intelligence device, the Q value that corresponds to the first sentiment state and the first action in the Q-value table using the following formula, Qₜ₊₁ (sₜ₊₁, aₜ₊₁)=(1λ) Qₜ (sₜ, aₜ)+λ[rₜ+γmax Qₜ (sₜ, aₜ)], where Qₜ₊₁ (sₜ₊₁, aₜ₊₁) represents the updated Q value that corresponds to the first sentiment state and the first action in the Q-value table, λ represents learning strength, Qₜ (sₜ, aₜ) represents the Q value that is prior to the update and that corresponds to the first sentiment state and the first action in the Q-value table, γ represents a discount factor, rₜ represents the first return rate, and max Qₜ (sₜ, aₜ) represents a largest Q value that is prior to the update and that corresponds to the first sentiment state in the Q-value table.

With reference to any one of the first aspect, or the foregoing possible implementations of the first aspect, in a third possible implementation of the first aspect, the method further includes determining, by the artificial intelligence device, a sentiment threshold level, and determining, by the artificial intelligence device, the preset threshold based on the sentiment threshold level. The optimized sentiment threshold can better meet a user's requirement by setting the sentiment threshold level, to improve prediction accuracy and improve communication efficiency and communication effects.

With reference to any one of the first aspect, or the foregoing possible implementations of the first aspect, in a fourth possible implementation of the first aspect, the method further includes determining, by the artificial intelligence device, a sentiment threshold level, and determining a sentiment threshold based on the monitoring information corresponding to the first sentiment state includes determining the sentiment threshold based on the sentiment threshold level and the monitoring information. The optimized sentiment threshold can better meet a user's requirement by setting the sentiment threshold level, to improve prediction accuracy and improve communication efficiency and communication effects.

With reference to the third or the fourth possible implementation of the first aspect, in a fifth possible implementation of the first aspect, determining, by the artificial intelligence device, a sentiment threshold level includes determining, by the artificial intelligence device, the sentiment threshold level based on at least one of personalized factor information, conversation scenario information, external environment information, and input information of the first user. According to the foregoing technical solution, when determining the sentiment threshold level, the artificial intelligence device considers an objective condition (namely, at least one of the personalized factor information, the conversation scenario information, the external environment information, and the input information of the first user) to improve prediction accuracy.

With reference to any one of the first aspect, or the foregoing possible implementations of the first aspect, in a sixth possible implementation of the first aspect, the method further includes determining, by the artificial intelligence device, whether current monitoring information is greater than the sentiment threshold when the artificial intelligence device determines the sentiment threshold, and sending indication information if the current monitoring information is greater than the sentiment threshold, where the indication information is used to prompt that the sentiment status of the first user changes if the second user performs the first action. In this way, the artificial intelligence device can prompt in a timely manner based on the determined sentiment threshold, another user communicating with the user to avoid any action that can change the sentiment status of the user.

According to a second aspect, an embodiment of this disclosure provides an artificial intelligence device. The artificial intelligence device includes units configured to perform any one of the first aspect or the possible implementations of the first aspect.

According to a third aspect, an embodiment provides an artificial intelligence device. The artificial intelligence device includes a processor, a memory, and an input apparatus. The processor is configured to execute an instruction stored in the memory and perform, in combination with the memory and the input apparatus, steps in any one of the first aspect or the possible implementations of the first aspect.

Another aspect provides a computer readable storage medium, where the computer readable storage medium stores an instruction, and when the instruction runs on a computer, the computer performs the methods according to the foregoing aspects.

Another aspect provides a computer program product including an instruction, and when the computer program product runs on a computer, the computer performs the methods according to the foregoing aspects.

### BRIEF DESCRIPTION OF DRAWINGS

FIG. 1 is a schematic flowchart of a method for determining a sentiment threshold according to an embodiment;

FIG. 2 is a structural block diagram of an artificial intelligence device according to an embodiment; and

FIG. 3 is a structural block diagram of an artificial intelligence device according to an embodiment.

### DESCRIPTION OF EMBODIMENTS

The following describes the technical solutions of this application with reference to the accompanying drawings.

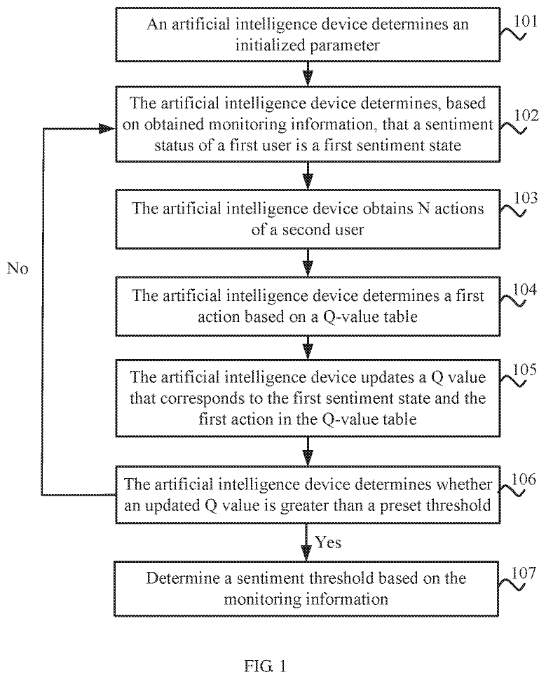

An artificial intelligence device in the embodiments of this disclosure is any device that can implement a method shown in FIG. 1, and may be, for example, a computer or a robot.

FIG. 1 is a schematic flowchart of a method for determining a sentiment threshold according to an embodiment.

Step 101. An artificial intelligence device determines an initialized parameter, where the initialized parameter includes a Q-value table and a preset threshold.

Each Q value in the Q-value table corresponds to a sentiment state and an action. For example, Table 1 is an example of a Q-value table.

TABLE 1

| | A1 | A2 | A3 | A4 | A5 |
|---|---|---|---|---|---|
| S1 | Q11 | Q12 | Q13 | Q14 | Q15 |
| S2 | Q21 | Q22 | Q23 | Q24 | Q25 |
| S3 | Q31 | Q32 | Q33 | Q34 | Q35 |
| S4 | Q41 | Q42 | Q43 | Q44 | Q45 |

Table 1 is a Q-value table including four rows and five columns. The four rows respectively represent four sentiment states. The four sentiment states are respectively S1, S2, S3, and S4. The five columns respectively represent five actions. The five actions are respectively A1, A2, A3, A4, and A5. Each Q value in the Q-value table corresponds to an action and a sentiment state. For example, Q11 represents a Q value whose sentiment state is S1 and whose action is A1, Q12 represents a Q value whose sentiment state is S1 and whose action is A2, and so on.

Optionally, in an embodiment, all Q values in the Q-value table are zeros in an initial state.

Step 102. The artificial intelligence device determines, based on obtained monitoring information, that a sentiment status of a first user is a first sentiment state.

The artificial intelligence device may obtain the monitoring information. The monitoring information may be obtained by a monitoring device by monitoring data such as physiological data and action data of the first user. The monitoring information may be one or more pieces of information that can be used to determine a sentiment status of a user. For example, the monitoring information may include action data and/or physiological data. The action data may include one or more of speech, a facial expression, a gesture, a standing posture, and the like. The physiological data may include one or more of a heart rate, a pulse, skin conductance, and body temperature. It should be understood that if the monitoring information is data expressed non-digitally such as action data, the data may be expressed digitally for ease of processing.

The monitoring device is a device, an apparatus, or a sensor that can obtain the monitoring information, and the monitoring device may be one or more devices. For example, the monitoring device may include a speech recognition device, a facial expression recognition device, a heart rate sensor, a temperature sensor, and the like. For another example, the monitoring device may alternatively be one device, and the device has a speech recognition function, a facial expression recognition function, and functions of obtaining a heart rate and body temperature. The monitoring device may be integrated with the artificial intelligence device, or may be an independent device, which is not limited in this embodiment.

The artificial intelligence device may directly determine the sentiment status of the first user based on the obtained monitoring information, or may determine the sentiment status of the first user after further processing the monitoring information, which is not limited in this embodiment.

Step 103. The artificial intelligence device obtains N actions of a second user, where the second user is a user who communicates with the first user, and N is a positive integer greater than or equal to 1.

The action in this embodiment is any action that is performed by the second user and that may be perceived by the first user, and includes but is not limited to speech data, a body movement, a facial expression action, and the like. For example, in a scenario of a dialog between the first user and the second user, the artificial intelligence device may obtain speech data of the second user. The speech data may include specific content, a tone, a speed, and other speech data of the second user. The artificial intelligence device may further obtain a body movement of the second user.

It should be understood that the second user may perform one or more actions in a dialog.

The artificial intelligence device may obtain the at least one action of the second user in a plurality of manners. For example, the artificial intelligence device may be provided with a built-in camera to obtain a body movement, a facial expression, and the like of the second user. The artificial intelligence device may also be provided with a built-in microphone to obtain the speech data of the second user. For another example, the camera and the microphone may alternatively be external devices, and the artificial intelligence device may obtain actions and speech data obtained by these external devices.

Step 104. The artificial intelligence device determines a first action based on the Q-value table, where each Q value in the Q-value table corresponds to a sentiment state and an action, a Q value that corresponds to the first sentiment state and the first action is a largest value in N Q values in the Q-value table, and an n^{th} Q value in the N Q values corresponds to the first sentiment state and an n^{th} action in the N actions, where n=1, . . . , N.

Assuming that a first sentiment state of the first user and determined by the artificial intelligence device is S1, and the N actions of the second user and determined by the artificial intelligence device include A1, A2, and A5, where Q11 is less than Q12, and Q12 is less than Q15, the first action determined by the artificial intelligence device is A5.

Step 105. The artificial intelligence device updates the Q value that corresponds to the first sentiment state and the first action in the Q-value table.

Updating the Q value that corresponds to the first sentiment state and the first action in the Q-value table includes updating, based on a first return rate, the Q value that corresponds to the first sentiment state and the first action in the Q-value table.

The artificial intelligence device may determine the first return rate based on the first action and/or the first sentiment state.

Optionally, in some embodiments, the artificial intelligence device may determine the first return rate based on a preset return rate table. The return rate table may include a plurality of return rates. Each return rate in the return rate table corresponds to an action and a sentiment status. The return rate in the return rate table may be determined based on an empirical value.

Optionally, in some other embodiments, the artificial intelligence device may determine the first return rate according to a preset formula.

Optionally, in some embodiments, the artificial intelligence device may update the Q value that corresponds to the first sentiment state and the first action in the Q-value table according to the formula:

Qₜ₊₁ (sₜ₊₁, aₜ₊₁)=(1−λ) Qₜ (sₜ, aₜ)+λ[rₜ+γmax Qₜ (sₜ, aₜ)], (Formula 1.1)

e Qₜ₊₁ (sₜ₊₁, aₜ₊₁) represents an updated Q value that corresponds to the first sentiment state and the first action in the Q-value table, λ represents learning strength, Qₜ (sₜ, aₜ) represents the Q value that is prior to the update and that corresponds to the first sentiment state and the first action in the Q-value table, γ represents a discount factor, rₜ represents the first return rate, and max Qₜ (sₜ, aₜ) represents a largest Q value that is prior to the update and that corresponds to the first sentiment state in the Q-value table.

Optionally, in some other embodiments, the artificial intelligence device may update the Q value that corresponds to the first sentiment state and the first action in the Q-value table according to the formula:

Qₜ₊₁ (sₜ₊₁, aₜ₊₁)=γQₜ (sₜ, aₜ)+λrₜ, (Formula 1.2)

where Qₜ₊₁ (sₜ₊₁, aₜ₊₁) represents the updated Q value that corresponds to the first sentiment) state and the first action in the Q-value table, λ represents learning strength, Qₜ (sₜ, aₜ) represents the Q value that is prior to the update and that corresponds to the first sentiment state and the first action in the Q-value table, γ represents a discount factor, and rₜ represents the first return rate.

Step 106. The artificial intelligence device determines whether an updated Q value is greater than a preset threshold. If the updated Q value is greater than the preset threshold, perform step 107, or if the updated Q value is not greater than the preset threshold, repeat step 102 to step 106 until a determined result in step 106 is that the updated Q value is greater than the preset threshold.

Step 107. Determine a sentiment threshold based on the monitoring information.

Optionally, in some embodiments, the preset threshold is determined based on an empirical value.

Optionally, in some other embodiments, the preset threshold is determined based on a sentiment threshold level. The artificial intelligence device may first determine a sentiment threshold level, and then determine the preset threshold based on the sentiment threshold level.

Optionally, in some embodiments, the artificial intelligence device may determine the sentiment threshold level based on at least one of personalized factor information, conversation scenario information, external environment information, and input information of the first user. According to the foregoing technical solution, when determining the sentiment threshold level, the artificial intelligence device considers an objective condition (namely, at least one of the personalized factor information, the conversation scenario information, the external environment information, and the input information of the first user) to improve prediction accuracy.

The personalized factor information is used to indicate a user's personalized characteristic, for example, a user's personality. Further, different persons have particular differences in stimuli from external things and a retention time in each sentiment state, or spontaneous transition between different sentiment states. Optionally, the personalized factor information of the first user may be obtained by training personality information of the first user based on a basic personality template library. A personalized factor library may be trained based on an existing mature basic personality template library studied in the academic world to learn and obtain personalized factors of different users. The personalized factor library can be used to simulate different persons' sentiment states to obtain change rules to further improve the prediction accuracy.

For example, the artificial intelligence device may determine the sentiment threshold level based on the personalized factor information of the first user. For example, the sentiment threshold level may be set to be relatively high if the first user is insensitive to external things and the sentiment threshold level may be set to be relatively low if the first user is sensitive to external things.

When the first user communicates with different persons, sentiment thresholds of the first user are different. For example, when communicating with a child, the first user is gentle and pleased, and a threshold triggering the sentiment status of the first user to change may be relatively high. For another example, when the first user communicates with some specific objects, the sentiment status of the first user fluctuates relatively greatly, and a threshold triggering the sentiment status of the first user to change may be relatively low. In this embodiment of this application, information related to the second user, for example, personalized factor information and identity information of the second user, is referred to as conversation scenario information.

Different external environments may also affect a sentiment status of a tested user. For example, a sentiment status change of the tested user varies between a terrifying atmosphere and an environment of being at home. In this embodiment of this application, information that is used for a sentiment prediction module to construct an external environment scenario and unrelated to the second user is referred to as external environment information. The external environment information may include at least one item of weather information, geographical location information of the first user, and the like. For example, the artificial intelligence device may set the sentiment threshold to be relatively high if the weather is good and the artificial intelligence device may set the sentiment threshold to be relatively low if the weather is bad.

In some other embodiments, the first user or the second user may directly enter a sentiment threshold level as required.

Optionally, in some embodiments, the sentiment threshold level may be set to be relatively high if the artificial intelligence device determines that related information (namely, personalized factor information, conversation scenario information, and external environment information) is never before encountered new information.

The sentiment threshold level may be set to be relatively low if the artificial intelligence device determines that the conversation scenario information is never before encountered new conversation scenario information.

A higher sentiment threshold level indicates a higher preset threshold determined based on the sentiment threshold level. Correspondingly, a lower sentiment threshold level indicates a lower preset threshold determined based on the sentiment threshold level. A curve of the change of the preset threshold corresponding to the sentiment threshold level may be linear or nonlinear, which is not limited in this embodiment.

Optionally, in some embodiments, a correspondence between the sentiment threshold level and the preset threshold is predetermined. In some other embodiments, the preset threshold may be determined based on the sentiment threshold level and an empirical value.

Each Q value in the Q-value table may have a corresponding preset threshold, and preset thresholds of different Q values may be the same or different. It should be understood that the preset threshold in step 106 is a preset threshold of the Q value that corresponds to the first sentiment state and the first action.

Optionally, when the preset threshold is determined based on the sentiment threshold level, the artificial intelligence device may directly determine that the monitoring information is the sentiment threshold.

Optionally, in some embodiments, the preset threshold may be the empirical value. In this case, the artificial intelligence device may determine the sentiment threshold based on the sentiment threshold level and the monitoring information.

For example, the artificial intelligence device determines, after M periods, that an updated Q value is greater than the preset threshold, where M is a positive integer greater than or equal to 2. In this case, the artificial intelligence device may determine that monitoring information in an (M-m)^{th} period is the sentiment threshold, where m is a positive integer greater than or equal to 1 and less than M. A value of m may be determined based on the sentiment threshold level. A higher sentiment threshold level indicates a larger value of m, and a lower sentiment threshold level indicates a smaller value of m.

For another example, the sentiment threshold is determined based on the monitoring information and the sentiment threshold level. For example, the monitoring information may be multiplied by a coefficient. A higher sentiment threshold level indicates a larger coefficient, and a lower sentiment threshold level indicates a smaller coefficient.

Certainly, in some embodiments, both the preset threshold and the sentiment threshold may be determined based on the sentiment threshold level. For a specific manner, refer to the foregoing embodiments. Details are not described herein.

In the technical solution shown in FIG. 1, the artificial intelligence device may optimize the sentiment threshold using a Q-learning method to improve communication efficiency and communication effects in different scenarios.

In addition, the optimized sentiment threshold can better meet a user's requirement by setting the sentiment threshold level to improve prediction accuracy and improve communication efficiency and communication effects.

Further, when the artificial intelligence device determines the sentiment threshold, the method may further include determining, by the artificial intelligence device, whether current monitoring information exceeds the sentiment threshold. If the current monitoring information exceeds the sentiment threshold, indication information may be sent. The indication information is used to prompt that the sentiment status of the first user changes if the second user performs the first action. In this way, the artificial intelligence device may prompt the second user in a timely manner with actions that may cause the sentiment status change of the first user. The second user may avoid corresponding actions that cause the sentiment status change of the first user. The artificial intelligence device may send the indication information in a plurality of manners, such as a voice prompt, a text prompt, and an image prompt, which is not limited in this embodiment.

Further, the artificial intelligence device may further determine a difference between an updated Q value and a Q value that is prior to the update. If the difference is less than a preset difference, it may be determined that a Q value that corresponds to the first sentiment state and the first action in the Q-value table still uses the Q value that is prior to the update. If the difference is greater than the preset difference, it may be determined that a Q value that corresponds to the first sentiment state and the first action in the Q-value table is the updated Q value.

Optionally, in some embodiments, if the updated Q value exceeds a preset threshold of the Q value, it may indicate that the sentiment status of the user changes from a current sentiment status to a specific sentiment state. There is a preset threshold of a corresponding Q value and a sentiment threshold for a change from each sentiment state to another sentiment state. For example, when the updated Q value exceeds a first preset threshold of the Q value, it may indicate that the sentiment status of the user changes from happiness to astonishment. For another example, when the updated Q value exceeds a second preset threshold of the Q value, it may indicate that the sentiment status of the user changes from astonishment to anger. It should be understood that, the example shown in FIG. 1 shows a method for determining a sentiment threshold. According to the method shown in FIG. 1, sentiment thresholds corresponding to different sentiment states may be determined.

In addition, the specific sentiment state may be an adjacent sentiment state of the current sentiment state, or may be a non-adjacent sentiment state. For example, a sentiment status changes from happiness to anger may experience the astonished state. The first preset threshold is less than the second preset threshold. In some embodiments, the preset threshold of the Q value may be the first preset threshold or the second preset threshold. In these embodiments, the intelligence device may set a sentiment threshold for each sentiment state of the first user. In some other embodiments, the preset threshold of the Q value may be directly set to the second preset threshold. In these embodiments, the intelligence device may only set a sentiment threshold for a concerned sentiment state (such as anger).

FIG. 2 is a structural block diagram of an artificial intelligence device according to an embodiment. As shown in FIG. 2, an artificial intelligence device 200 may include a processing unit 201, a storage unit 202, and an obtaining unit 203.

The obtaining unit 203 is configured to obtain N actions of a second user, where N is a positive integer greater than or equal to 1.

The storage unit 202 is configured to store a Q-value table.

The processor unit 201 is configured to perform the following steps:

Determining, based on monitoring information, that a sentiment status of a first user is a first sentiment state;

Obtaining the N actions obtained by the obtaining unit 203, where the second user is a user who communicates with the first user;

Determining a first action based on the Q-value table stored in the storage unit 202, where each Q value in the Q-value table corresponds to a sentiment state and an action, a Q value that corresponds to the first sentiment state and the first action is a largest value in N Q values in the Q-value table, and an n^{th} Q value in the N Q values corresponds to the first sentiment state and an n^{th} action in the N actions, where n=1, . . . , N.

Updating the Q value that corresponds to the first sentiment state and the first action in the Q-value table stored in the storage unit 202; and

Determining whether the updated Q value is greater than a preset threshold, determining the sentiment threshold based on the monitoring information when the updated Q value is greater than the preset threshold, and when the updated Q value is not greater than the preset threshold, repeating the foregoing steps until the sentiment threshold is determined, where an updated Q value greater than the preset threshold indicates that the sentiment status of the first user changes from the first sentiment state to a specific sentiment state.

Optionally, in some embodiments, the processing unit 201 is further configured to update, based on a first return rate, the Q value that corresponds to the first sentiment state and the first action in the Q-value table stored in the storage unit 202.

Optionally, in some embodiments, the processing unit 201 is further configured to update the Q value that corresponds to the first sentiment state and the first action in the Q-value table stored in the storage unit 202 using the following formula:

Qₜ₊₁ (sₜ₊₁, aₜ₊₁)=(1−λ)Qₜ (sₜ, aₜ)+λ[rₜ+γmax Qₜ (sₜ, aₜ)],

where Qₜ₊₁ (sₜ₊₁, aₜ₊₁) represents the updated Q value that corresponds to the first sentiment state and the first action in the Q-value table, λ represents learning strength, Qₜ (sₜ, aₜ) represents the Q value that is prior to the update and that corresponds to the first sentiment state and the first action in the Q-value table, γ represents a discount factor, rₜ represents the first return rate, and max Qₜ (sₜ, aₜ) represents a largest Q value that is prior to the update and that corresponds to the first sentiment state in the Q-value table.

Optionally, in some embodiments, the processing unit 201 is further configured to determine a sentiment threshold level, and the processing unit 201 is further configured to determine the preset threshold based on the sentiment threshold level.

Optionally, in some embodiments, the processing unit 201 is further configured to determine a sentiment threshold level, and the processing unit 201 is further configured to determine the sentiment threshold based on the sentiment threshold level and the monitoring information.

Optionally, the processing unit 201 is further configured to determine the sentiment threshold level based on at least one of personalized factor information, conversation scenario information, external environment information, and input information of the first user.

Optionally, in some embodiments, the artificial intelligence device 200 may further include an output unit. The processing unit 201 may be further configured to determine whether current monitoring information is greater than the sentiment threshold when the sentiment threshold is determined, and instruct the output unit to send out indication information if it is determined that the current monitoring information is greater than the sentiment threshold, where the indication information is used to prompt that the sentiment status of the first user changes if the second user performs the first action.

The storage unit 202 may be further configured to store the sentiment threshold level, the preset threshold, the sentiment threshold, and other information that are determined by the processing unit 201.

The processing unit 201 may be implemented using a processor. The storage unit 202 may be implemented using a memory. The obtaining unit 203 may be implemented using an input device such as a microphone and a camera. The output unit may be implemented using an output device such as a loudspeaker and a display.

The artificial intelligence device 200 shown in FIG. 2 can implement processes implemented in the method embodiment in FIG. 1. To avoid repetition, details are not described herein again.

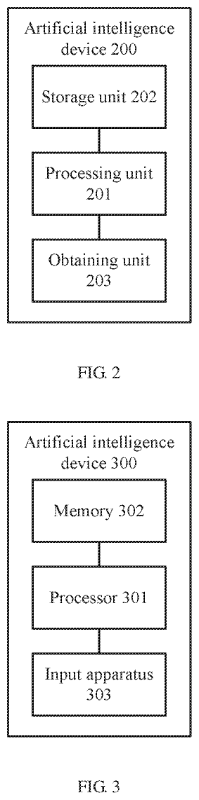

FIG. 3 is a structural block diagram of an artificial intelligence device according to an embodiment. As shown in FIG. 3, the artificial intelligence device 300 may include a processor 301, a memory 302, and an input apparatus 303. The memory 302 may be configured to store information such as a Q-value table, a sentiment threshold level, a preset threshold, and a sentiment threshold, and may be further configured to store a code, an instruction, and the like that are executed by the processor 301. Components in the artificial intelligence device 300 are coupled to each other using a bus system. In addition to a data bus, the bus system further includes a power bus, a control bus, and a state signal bus.

The artificial intelligence device 300 shown in FIG. 3 can implement processes implemented in the method embodiment in FIG. 1. To avoid repetition, details are not described herein again.

A person of ordinary skill in the art will be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this disclosure.

It will be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in this disclosure, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual requirements to achieve the objectives of the solutions of the embodiments.

In addition, functional units in the embodiments may be integrated into one processing unit, or each of the units may exist alone physically, or two or more units are integrated into one unit.

All or some of the foregoing embodiments may be implemented by means of software, hardware, firmware, or any combination thereof. When software is used to implement the embodiments, the embodiments may be implemented completely or partially in a form of a computer program product. The computer program product includes one or more computer instructions. When the computer program instructions are loaded and executed on the computer, the procedure or functions according to the embodiments of this application are all or partially generated. The computer may be a general-purpose computer, a dedicated computer, a computer network, or other programmable apparatuses. The computer instructions may be stored in a computer-readable storage medium, or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, and microwave, or the like) manner. The computer-readable storage medium may be any usable medium accessible by a computer, or a data storage device, such as a server or a data center, integrating one or more usable media. The usable medium may be a magnetic medium (for example, a soft disk, a hard disk, or a magnetic tape), an optical medium (for example, a digital versatile disc (DVD)), a semiconductor medium (for example, a solid-state drive (SSD)), or the like.

The foregoing descriptions are merely specific implementations, but are not intended to limit the protection scope of this disclosure. Any variation or replacement readily figured out by a person skilled in the art within the technical scope disclosed shall fall within the protection scope of the claims.

1. A sentiment threshold determining method, implemented by an artificial intelligence device, comprising:
obtaining monitoring information of a first user;
determining, based on the monitoring information, that a sentiment status of the first user is a first sentiment state;
obtaining N actions of a second user in communication with the first user, and wherein N is a positive integer greater than or equal to one;
determining a first action based on a Q-value table, wherein each Q value in the Q-value table corresponds to a sentiment state and an action, wherein a first Q value corresponding to the first sentiment state and the first action is a largest value in N Q values in the Q-value table, wherein an n^{th} Q value in the N Q values corresponds to the first sentiment state and an n^{th} action in the N actions, and wherein n=1, . . . N;
updating the first Q value to obtain an updated Q value; and
determining whether the updated Q value is greater than a preset threshold;
determining a sentiment threshold based on the monitoring information by repeating the foregoing steps until the updated Q value is greater than the preset threshold; and
updating the sentiment status based on the sentiment threshold.

2. The sentiment threshold determining method of claim 1, wherein updating the first Q value comprises updating, based on a first return rate, the first Q value to obtain the updated Q value.

3. The sentiment threshold determining method of claim 2, wherein updating the first Q value comprises updating the first Q value using the following formula:
Qₜ₊₁ (sₜ₊₁, aₜ₊₁)=(1−λ) Qₜ (sₜ, aₜ)+λ[rₜ+γQₜ (sₜ, aₜ)],
wherein Qₜ₊₁ (sₜ₊₁, aₜ₊₁) represents the updated Q, wherein λ represents a learning strength, wherein Qₜ (sₜ, aₜ) represents the first Q value, wherein γ represents a discount factor, wherein rₜ represents the first return rate, and wherein max Qₜ (sₜ, aₜ) represents a largest Q value prior to updating the first Q value corresponding to the first sentiment state in the Q-value table.

4. The sentiment threshold determining method of claim 1, further comprising:
determining a sentiment threshold level; and
determining the preset threshold based on the sentiment threshold level.

5. The sentiment threshold determining method of claim 1, further comprising determining a sentiment threshold level, and wherein determining the sentiment threshold based on the monitoring information comprises determining the sentiment threshold based on the sentiment threshold level and the monitoring information.

6. The sentiment threshold determining method of claim 4, wherein determining the sentiment threshold level comprises determining the sentiment threshold level based on at least one of personalized factor information, conversation scenario information, external environment information, or input information of the first user.

7. The sentiment threshold determining method of claim 1, further comprising:
determining whether current monitoring information is greater than the sentiment threshold; and
sending indication information to a device of the second user when the current monitoring information is greater than the sentiment threshold, wherein the indication information prompts that the sentiment status of the first user changes when the second user performs the first action.

8. An artificial intelligence device, wherein the artificial intelligence device comprises:
an input apparatus configured to:
obtain monitoring information of a first user; and
obtain N actions of a second user, wherein N is a positive integer greater than or equal to one, and wherein the second user communicates with the first user;
a memory coupled to the input apparatus and configured to store a Q-value table; and
a processor coupled to the input apparatus and the memory and configured to:
determine, based on the monitoring information, that a sentiment status of the first user is a first sentiment state;
obtain the N actions from the input apparatus;
determine a first action based on the Q-value table stored in the memory, wherein each Q value in the Q-value table corresponds to a sentiment state and an action, wherein a first Q value corresponding to the first sentiment state and the first action is a largest value in N Q values in the Q-value table, wherein an n^{th} Q value in the N Q values corresponds to the first sentiment state and an n^{th} action in the N actions, and wherein n=1, . . . N;
update the first Q value to obtain an updated Q value;
determine whether the updated Q value is greater than a preset threshold;
determine a sentiment threshold based on the monitoring information when the updated Q value is greater than the preset threshold; or
repeat the foregoing steps when the updated Q value is not greater than the preset threshold; and
update the sentiment status based on the determined sentiment threshold.

9. The artificial intelligence device of claim 8, wherein the processor is further configured to update, based on a first return rate, the first Q value to obtain the updated Q value.

10. The artificial intelligence device of claim 8, wherein the processor is further configured to update the first Q value using the following formula:
Qₜ₊₁ (sₜ₊₁, aₜ₊₁)=(1−λ) Qₜ (sₜaₜ)+λ[rₜ+γmax Qₜ (sₜ, aₜ)],
wherein Qₜ₋₁ (sₜ₊₁, aₜ₊₁) represents the updated Q value, wherein λ represents a learning strength, wherein Qₜ (sₜ, aₜ) represents the first Q value, wherein γ represents a discount factor, wherein rₜ represents a first return rate, and wherein max Qₜ (sₜ, aₜ) represents a largest Q value prior to updating the first Q value corresponding to the first sentiment state in the Q-value table.

11. The artificial intelligence device of claim 8, wherein the processor is further configured to:
determine a sentiment threshold level; and
determine the preset threshold based on the sentiment threshold level.

12. The artificial intelligence device of claim 8, wherein the processor is further configured to:
determine a sentiment threshold level; and
determine the sentiment threshold based on the sentiment threshold level and the monitoring information.

13. The artificial intelligence device of claim 11, wherein the processor is further configured to determine the sentiment threshold level based on at least one of personalized factor information, conversation scenario information, external environment information, or input information of the first user.

14. The artificial intelligence device of claim 8, further comprising an output apparatus coupled to the processor, and wherein the processor is further configured to:
determine whether current monitoring information is greater than the sentiment threshold; and
instruct the output apparatus to send indication information to a device of the second user when the current monitoring information is greater than the sentiment threshold, wherein the indication information prompts that the sentiment status of the first user changes when the second user performs the first action.

15. A sentiment threshold determining method, implemented by an artificial intelligence device, comprising:
obtaining monitoring information of a first user;
determining, based on the monitoring information, that a sentiment status of the first user is a first sentiment state;
obtaining N actions of a second user, wherein the second user communicates with the first user, and wherein N is a positive integer greater than or equal to one;
determining a first action based on a Q-value table, wherein each Q value in the Q-value table corresponds to a sentiment state and an action, wherein a first Q value corresponding to the first sentiment state and the first action is a largest value in N Q values in the Q-value table, wherein an n^{th} Q value in the N Q values corresponds to the first sentiment state and an n^{th} action in the N actions, and wherein n=1, . . . N;
updating the first Q value to obtain an updated Q value; and
determining whether the updated Q value is greater than a preset threshold, wherein an updated Q value greater than the preset threshold indicates that the sentiment status of the first user changes from the first sentiment state to a specific sentiment state;
repeating the foregoing steps until the updated Q value is greater than the preset threshold;
determining a sentiment threshold based on the monitoring information; and
updating the sentiment status based on the determined sentiment threshold.

16. The sentiment threshold determining method of claim 15, wherein updating the first Q value comprises updating the first Q value using the following formula:
Qₜ₊₁ (sₜ₊₁, aₜ₊₁)=(1−λ) Qₜ (sₜ, aₜ)+λ[rₜ+γmax Qₜ (sₜ, aₜ)],
wherein Qₜ₊₁ (sₜ₊₁, aₜ₊₁) represents the updated Q value, wherein λ represents a learning strength, wherein Qₜ (sₜ, aₜ) represents the first Q value, wherein γ represents a discount factor, wherein rₜ represents a first return rate, and wherein max Qₜ (sₜ, aₜ) represents a largest Q value prior to updating the first Q value corresponding to the first sentiment state in the Q-value table.

17. The sentiment threshold determining method of claim 15, further comprising:
determining a sentiment threshold level; and
determining the preset threshold based on the sentiment threshold level.

18. The sentiment threshold determining method of claim 17, wherein determining the sentiment threshold level comprises determining the sentiment threshold level based on at least one of personalized factor information, conversation scenario information, external environment information, or input information of the first user.

19. The sentiment threshold determining method of claim 15, further comprising determining a sentiment threshold level, and wherein determining the sentiment threshold based on the monitoring information comprises determining the sentiment threshold based on the sentiment threshold level and the monitoring information.

20. The sentiment threshold determining method of claim 15, further comprising:
determining whether current monitoring information is greater than the sentiment threshold; and
sending indication information to a device of the second user when the current monitoring information is greater than the sentiment threshold, wherein the indication information prompts that the sentiment status of the first user changes when the second user performs the first action.
